(19) United States
(12) Patent Application Publication
(10) Pub. No.: US 2005/0223361 A1
(43) Pub. Date: Oct. 6, 2005

(54) Software testing based on changes in execution paths

(76) Inventor: John L. Belbute, San Diego, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 10/817,386

(22) Filed: Apr. 1, 2004

(51) Int. Cl. G06F 9/44

(52) U.S. Cl. 717/124

(57) ABSTRACT

Non-redundant software testing is provided based on changes in the execution paths of a software program. Upon changes to the code of the software program, changed or new execution paths are identified. Test cases capable of traversing the changed or new execution paths are then identified and executed to test the modified code. The difference between a first plurality of execution paths of the software program before the changes to the code and a second plurality of the execution paths of the software program after the changes to the code is identified. Test cases that intersect the changed paths may be identified and new test cases may be developed that would execute the changed paths.

### BACKGROUND OF THE INVENTION

1. Field of the Invention

The present invention relates in general to software testing. Specifically, the present invention relates to software testing based on changes in the execution paths of a software program.

2. Description of the Related Art

Software testing is an important element of software engineering and a significant phase in development and deployment of computer software. To produce robust software, especially in mission critical areas such as military control, space missions, financial and biomedical engineering, adequate testing is needed. Testing can be costly as it requires substantial amount of engineer time and often adds to the delay of product release. Efficiency of testing is thus of great importance.

Software testing typically includes the development and execution of a number of test cases to various modules or components of a software product. The test cases are generally designed to exercise the various functions, execution paths, memory and file operations, and other capabilities of the product. However, it is not uncommon that redundant test cases are executed during the software testing process. Test cases are executed multiple times on a software program where the software code remains unchanged, due to a general lack of knowledge with respect to the portions of the code that have been tested and those that have not, as well as a related lack of knowledge with respect to which portions of the software code a given test case is capable of testing. Executing test cases multiple times on unmodified software code represents a waste of time and resources. Such redundant testing adds to the overhead of software development.

The waste and inefficiency in testing is compounded by the problem of insufficient testing. Given a particular software program, it is often difficult to achieve a high level of code coverage of test cases. This is especially the case with software programs that involve complex controls, interfaces, and communications. Certain parts of the code may not be covered by any test case, whereas certain other parts of the code might have been tested repetitively by one or more test cases.

There is a need, therefore, to minimized the inefficiency and improve test case coverage in software testing. There is a need for non-redundant software testing that targets the portion of the code that has been modified or that has not otherwise been tested before. There is a need to identify or develop test cases that would execute the portion of the code that has been modified or that has not been tested before.

### SUMMARY OF THE VARIOUS EMBODIMENTS

The present invention provides various embodiments for software testing using non-redundant test cases based on changes in the execution paths of a software program. Testing is targeted at changes made to the code of the software program during various phases of software development and quality assurance. Only test cases that test the changed paths are executed. The paths that remain unchanged have presumably been tested before using the existing test cases. These existing test cases that test the unchanged paths are therefore considered redundant. They are not executed upon changes to the code.

According to one embodiment, changed or new execution paths are identified upon changes to the code of the software program. Test cases that would execute the changed or new execution paths are then identified and run to test the changed code. The identification of changed and new paths may be performed by identifying the one or more modules in the software program that have been changed and determining whether the changed modules caused changes in the execution paths. In one embodiment, the difference between a first plurality of execution paths of the software program before the changes to the code and a second plurality of the execution paths of the software program after the changes to the code is identified. The difference between the first and second pluralities comprises at least one of a changed or new execution path.

According to another embodiment, each test case of a plurality of existing test cases is evaluated based on the names and the parameters of one or more methods invoked by the test case. A determination is then made as to whether the methods of the test case involve changed paths and, hence, whether the test case would execute the changed paths. In another embodiment, test cases intersecting the changed paths are identified. These test cases are represented by strings of node numbers that share one or more nodes with the changed paths. The test case is executed if it is determined that it would intersect the changed paths. The test case is disregarded and not executed if it is determined that it would not execute the changed paths.

In another embodiment, once the new or changed paths are identified, the names and parameters of the methods involved in the new or changed paths are consulted and one or more new test cases are developed that would invoke these methods. Such new test cases would therefore be capable of traversing the new and changed paths. The new test cases are then executed to test the changed code of the software program.

A system for software testing is provided. The system is adapted to execute test cases that intersect changed paths upon modification to the software program being tested. The system includes means for identifying changed paths and means for identifying test cases that intersect changed path and hence are capable of executing changed paths. The identifying means are software, hardware, firmware, or combinations thereof according to various embodiments.

### BRIEF DESCRIPTION OF THE DRAWINGS

FIG. 1 is a flow chart showing the steps of software testing using non-redundant test cases according to one embodiment.

FIG. 2 is a screenshot of a control flow graph showing execution paths of a software module according to one embodiment.

FIG. 3 is a screenshot of a control flow graph showing the changed execution paths due to modifications to the code of the software module of FIG. 2 according to one embodiment.

FIG. 4 is a diagram showing elements of a software testing system according to one embodiment, as well as various processes involved.

### DETAILED DESCRIPTION OF THE VARIOUS EMBODIMENTS

In accordance with the present invention, efficient and adequate software testing is achieved by understanding the control and data flow of the software program to be tested. To track parts of a software program that have been tested and parts that have not, execution paths are used according to one embodiment.

Execution paths of a software program are defined in the control flow graph of the software program. Control flow graphs describe the logic structure of software modules. A module refers to a single function or subroutine in typical languages. It has a single entry and exit point and is able to be used as a design component via a call/return mechanism. In a control flow graph, the nodes represent computational statements or expressions and the edges represent transfer of control between nodes. See, Watson A J. and McCabe T J., “Structured Testing: A Testing Methodology Using the Cyclomatic Complexity Metric,” NIST Special Publication 500-235, National Institute of Standards and Technology, August, 1996. Each possible execution path of a software module has a corresponding path from the entry to the exit node of the module's control flow graph. This correspondence provides a foundation of the structured testing methodology.

Structured testing may be used in the white box or code-based testing approach. In white box testing, the software implementation itself is used to guide testing. Structured testing requires that each decision outcome be tested independently. Source code instrumentation facilitates the testing. The criterion for the structured testing is to test a baseline set of paths through the control flow graph of each module. This means that any additional path through the module's control flow graph can be expressed as a linear combination of paths that have been tested. Therefore, the structured testing criterion provides a way to determine whether testing is complete; it measures the quality or adequacy of the testing.

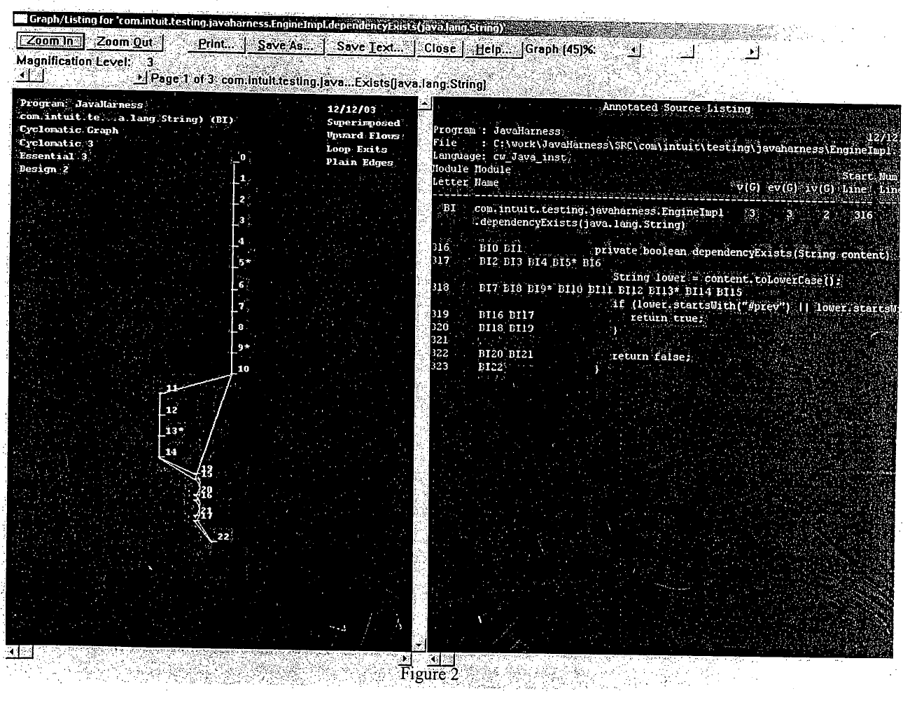

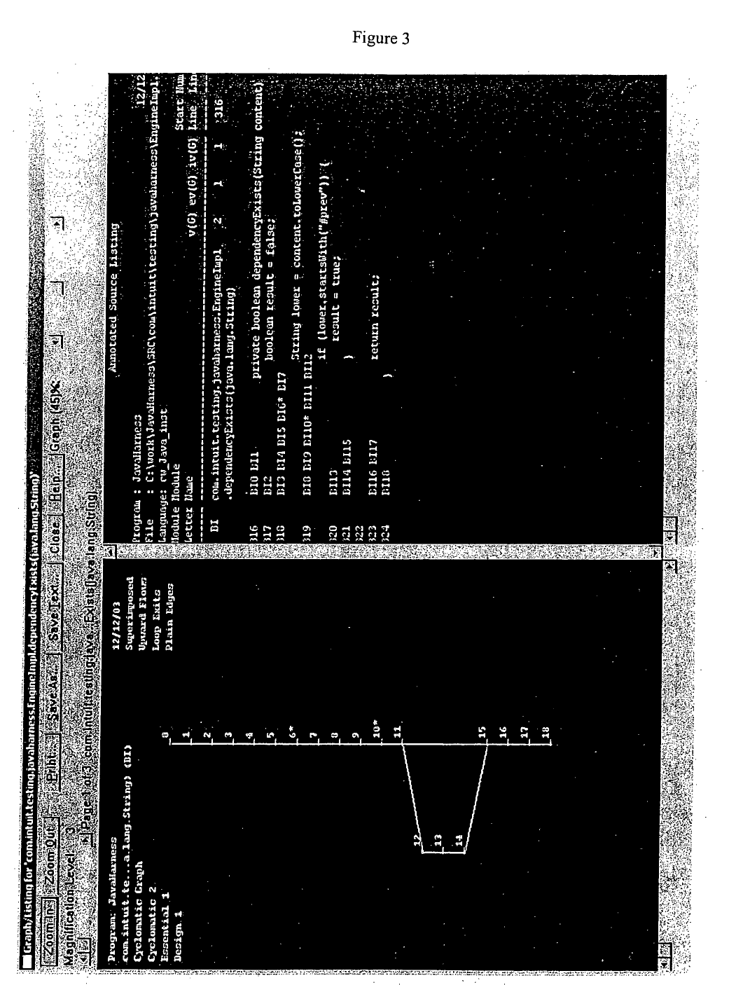

Cyclomatic complexity quantifies the amount of decision logic in a single software module. See, McCabe, T. J., “A Complexity Measure”, IEEE Trans. Software Eng., vol. 2, no. 4, pp. 308-320 (December 1976). For each software module, cyclomatic complexity is defined to be e−n+2, where e and n are the number of edges and nodes in the control flow graph, respectively. Cyclomatic complexity is referred to in some embodiments as v(G) (see also, FIGS. 2 and 3), where v refers to the cyclomatic number in graph theory and G indicates that the complexity is a function of the graph. Related to v(G), iv(G) is the module design complexity, defined as the cyclomatic complexity of the reduced graph after design reduction has been performed. The essential complexity, ev(G), of a module is derived by first removing structured programming primitives from the module's control flow graph until the graph cannot be reduced any further, and then calculating the cyclomatic complexity of the reduced graph. See supra, Watson A J. and McCabe T J.

Given a software program under testing, its cyclomatic complexity and control flow graph informs the identification of a set of control paths, also referred to as execution paths, to satisfy the structured testing criterion. For example, a baseline method described in Watson A J. and McCabe T J. may be used to identify such a set of execution paths. Non-redundant software testing according to one embodiment of this disclosure is based on the identification of such execution paths of a software program.

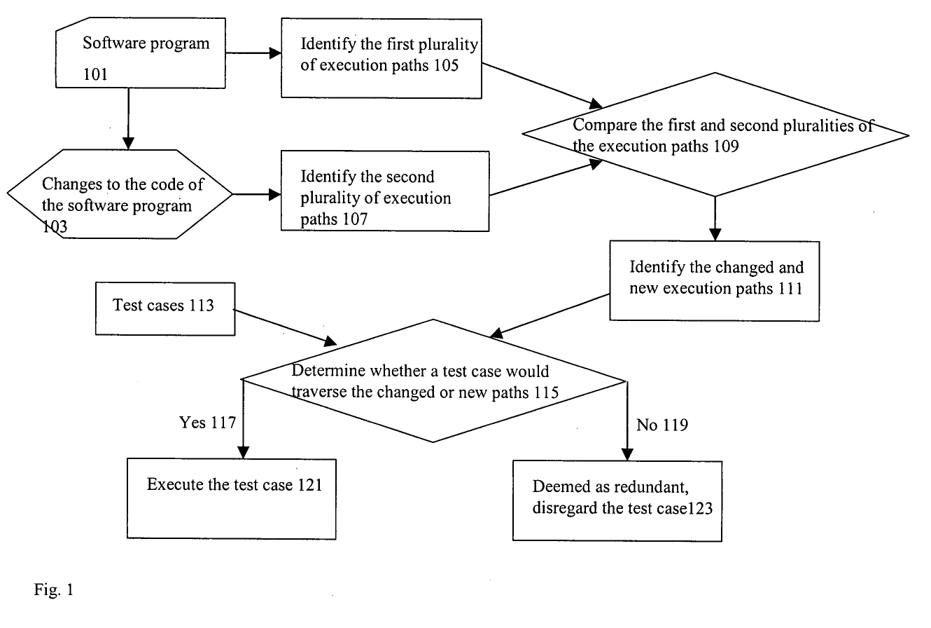

Referring to FIG. 1, a series of operations are performed in one embodiment for testing a software program using non-redundant test cases based on changed execution paths. A software program 101 is subject to testing. A first plurality of execution paths are identified 105 for the software program 101. Upon changes 103 to the code of the software program 101, a second plurality of execution paths are identified 107. The first 105 and second 107 pluralities of the execution paths are then compared 109 and thereby the difference between the first 105 and second 107 pluralities is determined. The difference may include at least a changed or a new execution path 111. After the changed and new execution paths are identified 111, each test case from the available set of test cases 113 is evaluated to determine whether it is capable of traversing the changed or new paths 115. If it is determined that the test case is capable of 117 traversing the changed or new paths, the test case is selected to be executed to test the modified code. If it is determined that the test case is not capable of 119 traversing the changed or new paths, the test case is deemed as redundant and disregarded without being executed. Once the test cases have been evaluated, the selected test cases are executed on the modified code.

A software program may have one or more modules. In one embodiment, at least one module is changed upon changing of the code. The changed and new execution paths are identified by first identifying the changed module and then determining whether the changed module causes changes in the execution paths.

For example, a baseline report of program modules and execution paths may be captured first in a unit test plan. This report lists a first plurality of execution paths of the program; it may be produced using a software testing aid such as McCabe™ IQ2 Suite, available from McCabe & Associates Inc. of Columbia, Md. When changes are made to the code of the program, execution paths are likely to be affected. To determine which paths are changed and whether new paths appeared, one may first evaluate the program modules and determine which methods have been affected. This may be accomplished, for example, by running a report using McCabe™ IQ2 to check the status of the modules. Once the likely affected methods are identified, one may examine the updated unit test plan, which includes information on the second plurality of execution paths after the changes to the code, and thereby determine whether the likely affected methods have actually caused changes in the execution paths.

Consider a test harness written in Java that has over 450 modules and includes over 850 paths. Suppose one method, dependencyExists, is modified. The original method reads as follows:

```
private boolean dependencyExists(String content) {
      String lower = content.toLowerCase( );
      if (lower.startsWith(“#prev”) || lower.startsWith(“#entry”))
{
            return true;
      }
      return false;
}
```

Two small changes are made in the modified method: the condition is modified to only check for the string “#prev” rather than both “#prev” and “#entry,” and a Boolean variable “result” is created to track the condition.

A tabular report is generated using McCabe™ IQ2 Suite that shows the status of each module. The report lists the names of the modules and the v(G), ev(G), and iv(G) values for each module. Annotation is provided in the report for each module on whether a given module is likely to have been changed. See below, the last column: “Changed.” Shown below is a segment of the report that includes certain modules among the over 450 in the entire program. Because this is the baseline original report, all the modules are marked in column “Changed” as “FALSE,” indicating that the modules have not yet been modified.

| Module Name | v(G) | ev(G) | iv(G) | Changed |
|---|---|---|---|---|
| .EngineImpl.runSingleSuite(jav | 11 | 1 | 11 | FALSE |
| com.intuit.testing.javaharness | | | | |
| .EngineImpl.resolveTokens(com. | 23 | 1 | 23 | FALSE |
| com.intuit.testing.javaharness | | | | |
| .EngineImpl.processPrevTestCas | 3 | 3 | 3 | FALSE |
| com.intuit.testing.javaharness | | | | |
| .EngineImpl.getTestCaseIndexBy | 3 | 3 | 2 | FALSE |
| com.intuit.testing.javaharness | | | | |
| .EngineImpl.dependencyExists(j | 4 | 1 | 4 | FALSE |
| com.intuit.testing.javaharness | | | | |
| .EngineImpl.createTestLog(java | 1 | 1 | 1 | FALSE |
| com.intuit.testing.javaharness | | | | |
| .EngineImpl.getBackupSuffix( ) | 5 | 1 | 5 | FALSE |
| com.intuit.testing.javaharness | | | | |
| .EngineImpl.backupLog(java.lan | 10 | 6 | 7 | FALSE |
| com.intuit.testing.javaharness | | | | |
| .EngineImpl.copyFile(java.lang | 3 | 1 | 2 | FALSE |
| com.intuit.testing.javaharness | | | | |
| .EngineImpl.getDataFiles(java. | 6 | 1 | 5 | FALSE |
| com.intuit.testing.javaharness | | | | |
| .EngineImpl.createTestSuite(ja | 1 | 1 | 1 | FALSE |
| com.intuit.testing.javaharness | | | | |
| .EngineImpl.loadConfig(java.ut | 1 | 1 | 1 | FALSE |
| com.intuit.testing.javaharness | | | | |
| .EngineImpl.display(java.lang. | 3 | 3 | 3 | FALSE |
| com.intuit.testing.javaharness | | | | |
| .EngineImpl.setTestResult(int, | 1 | 1 | 1 | FALSE |
| com.intuit.testing.javaharness | | | | |

Upon changes to the code, a report on all the modules and their parameters is regenerated using McCabe™ IQ2 Suite. As shown below, two methods are identified by the “TRUE” flag in the “Changed” column as likely to have been affected by the code modification: dependencyExists, which is the method that has in fact been modified, and runSingleSuite, which is a method that calls dependencyExists. The execution paths of the program are then examined to determine whether these two methods have caused any changes in the paths.

| | | | iv | | |
|---|---|---|---|---|---|
| Module Name | v(G) | ev(G) | (G) | Changed | |
| .EngineImpl.runTests(java.util | 3 | 1 | 3 | TRUE | <---- |
| com.intuit.testing.javaharness | | | | | |
| .EngineImpl.runSingleSuite(jav | 11 | 1 | 11 | FALSE | |
| com.intuit.testing.javaharness | | | | | |
| .EngineImpl.resolveTokens(com. | 23 | 1 | 23 | FALSE | |
| com.intuit.testing.javaharness | | | | | |
| .EngineImpl.processPrevTestCas | 3 | 3 | 3 | FALSE | |
| com.intuit.testing.javaharness | | | | | |
| .EngineImpl.getTestCaseIndexBy | 2 | 1 | 1 | TRUE | <---- |
| com.intuit.testing.javaharness | | | | | |
| .EngineImpl.dependencyExists(j | 4 | 1 | 4 | FALSE | |
| com.intuit.testing.javaharness | | | | | |
| .EngineImpl.createTestLog(java | 1 | 1 | 1 | FALSE | |
| com.intuit.testing.javaharness | | | | | |
| .EngineImpl.getBackupSuffix( ) | | | | | |

As part of the unit test plan, the following shows the execution paths of the module dependencyExists before the code is modified. Each path is represented by a string of node numbers. “TRUE” means that the relevant condition at a branching point is met whereas “False” means that the condition is not met.

Module: com.intuit.testing.javaharness.EngineImpl.dependencyExists(java.lang.String)

```
Cyclomatic Test Path 1 (of 3): 0 1 2 3 4 5 6 7 8 9 10 15 16 17 22
    318( 10): lower . startsWith (“#prev”) ==> TRUE
Cyclomatic Test Path 2 (of 3): 0 1 2 3 4 5 6 7 8 9 10 11 12 13 14 15
16 17 22
    318( 10): lower . startsWith (“#prev”) ==> FALSE
    318( 14): lower . startsWith (“#entry”) ==> TRUE
Cyclomatic Test Path 3 (of 3): 0 1 2 3 4 5 6 7 8 9 10 11 12 13 14 19
20 21 22
    318( 10): lower . startsWith (“#prev”) ==> FALSE
    318( 14): lower . startsWith (“#entry”) ==> FALSE
```

There are three possible paths. In Path 1, variable “lower” starts with “prev.” In Path 2, the variable “lower” starts with “prev” and not “entry.” In Path 3, the variable “lower” starts with neither “prev” nor “entry.” After code modification, the execution paths of the module dependencyExists are shown below:

Module: com.intuit.testingjavaharness.EngineImpl.dependencyExists(java.lang.String)

```
Cyclomatic Test Path 1 (of 2): 0 1 2 3 4 5 6 7 8 9 10 11 15 16 17 18
    319( 11): lower . startsWith (“#prev”) ==> FALSE
Cyclomatic Test Path 2 (of 2): 0 1 2 3 4 5 6 7 8 9 10 11 12 13 14 15
16 17 18
    319( 11): lower . startsWith (“#prev”) ==> TRUE
```

There are two possible paths after the modification. In Path 1, the variable “lower” starts with anything other than “prev.” In Path 2, the variable “lower” starts with “prev.” By comparing the execution paths before and after the changes to the code, it is clear that the paths involving this module have indeed been changed. See also, the control flow graphs showing the original paths and the changed paths in the left panels of FIGS. 2 and 3, respectively. The original and modified code of the module dependencyExists is displayed in the right panels of FIGS. 2 and 3, respectively. The applicable cyclomatic values, v(G), ev(G), and iv(G), are also shown in the right panels of FIGS. 2 and 3.

However, the same analysis for another module, runSingleSuite, leads to a different result. The module runSingleSuite calls the module dependencyExists. Also part of the unit test plan, the following shows the execution paths of the module runSingleSuite before the code is modified:
Module: com.intuit.testingjavaharness.EngineImpl.runSingleSuite(java.util.HashMap)
Cyclomatic Test Path 1(of 3): 0 1 2 3 4 5 6 7 8 9 10 11 12 13 14 15 16 17 18 19 20 21 22 23 24 25 26 27 28 29 30 31 32 33 34 35 36 37 38 39 40 41 42 43 44 45 46 47 48 49 50 5152 53 54 55 56 57 58 59 60 61 62 63 64 65 66 67 68 69 70 71 72 128 129
Cyclomatic Test Path 2 (of 3): 0 1 2 3 4 5 6 7 8 9 10 11 12 13 14 15 16 17 18 19 20 21 22 23 24 25 26 27 28 29 30 31 32 33 34 35 36 37 38 39 40 41 42 43 44 45 46 47 48 49 50 51 52 53 54 55 56 57 58 59 60 61 62 63 64 65 66 67 68 69 70 71 72 73 74 75 76 77 78 79 80 81 82 83 84 85 86 87 88 89 90 91 99 100 101 102 103 104 105 106 107 108 109 110 111 112 113 114 115 116 117 118 119 120 121 122 123 124 125 126 127 72 128 129
Cyclomatic Test Path 3 (of 3): 0 1 2 3 4 5 6 7 8 9 10 11 12 13 14 15 16 17 18 19 20 21 22 23 24 25 26 27 28 29 30 31 32 33 34 35 36 37 38 39 40 41 42 43 44 45 46 47 48 49 50 51 52 53 54 55 56 57 58 59 60 61 62 63 64 65 66 67 68 69 70 71 72 73 74 75 76 77 78 79 80 81 82 83 84 85 92 93 94 95 96 97 98 99 100 101 102 103 104 105 106 107 108 109 110 111 112 113 114 115 116 117 118 119 120 121 122 123 124 125 126 127 72 128 129

There are three paths identified, each of which is represented by a string of node numbers. After the code is modified, the execution paths of the module runSingleSuite are shown below:
Module: com.intuit.testingjavaharness.EngineImpl.runSingleSuite(java.util.HashMap)
Cyclomatic Test Path 1 (of 3): 0 1 2 3 4 5 6 7 8 9 10 11 12 13 14 15 16 17 18 19 20 21 22 23 24 25 26 27 28 29 30 31 32 33 34 35 36 37 38 39 40 41 42 43 44 45 46 47 48 49 50 51 52 53 54 55 56 57 58 59 60 61 62 63 64 65 66 67 68 69 70 71 72 128 129
Cyclomatic Test Path 2 (of 3): 0 1 2 3 4 5 6 7 8 9 10 11 12 13 14 15 16 17 18 19 20 21 22 23 24 25 26 27 28 29 30 31 32 33 34 35 36 37 38 39 40 41 42 43 44 45 46 47 48 49 50 51 52 53 54 55 56 57 58 59 60 61 62 63 64 65 66 67 68 69 70 71 72 73 74 75 76 77 78 79 80 81 82 83 84 85 86 87 88 89 90 91 99 100 101 102 103 104 105 106 107 108 109 110 111 112 113 114 115 116 117 118 119 120 121 122 123 124 125 126 127 72 128 129
Cyclomatic Test Path 3 (of 3): 0 1 2 3 4 5 6 7 8 9 10 11 12 13 14 15 16 17 18 19 20 21 22 23 24 25 26 27 28 29 30 31 32 33 34 35 36 37 38 39 40 41 42 43 44 45 46 47 48 49 50 51 52 53 54 55 56 57 58 59 60 61 62 63 64 65 66 67 68 69 70 71 72 73 74 75 76 77 78 79 80 81 82 83 84 85 92 93 94 95 96 97 98 99 100 101 102 103 104 105 106 107 108 109 110 111 112 113 114 115 116 117 118 119 120 121 122 123 124 125 126 127 72 128 129

The strings representing all three paths remain unchanged after the modification. Therefore, unlike the paths involving dependencyExists, the paths involving runSingleSuite have not been changed. The information on the changed and new execution paths is then used to identify test cases from the existing pool of test cases or guide the development of new test cases that are capable of executing these paths. For instance, the analysis of the changed paths involving dependencyExists reveals that, in this example, only tests includes a value for the variable “lower” in the method dependencyExists that starts with “prev” or without “prev” need to be executed. Other tests would not execute changed paths and therefore need not be executed again.

To perform testing using non-redundant test cases, each test case is examined to determine whether it is capable of executing the changed paths or the new paths that have been identified. For example, consider a given test case that has been defined to invoke one or more methods. The names and parameters of these methods may be parsed and evaluated to determine whether they match the methods involved in the identified new or changed execution paths. If a match were found, the test case would be capable of executing the new or changed paths as identified. The test case is then executed to test the modified code. If no match is found, on the other hand, the test case is considered as redundant, as it only test the portion of the program that has not been modified and presumably has been tested before. It is thus unnecessary to run that test case upon changes to the code.

New test cases may also be developed to specifically invoke the methods involved in the changed and new execution paths with the relevant parameters. The information provided in a unit test plan or any other analysis of execution paths enables a test engineer to write such test cases. Test cases may also be automatically generated based on such information.

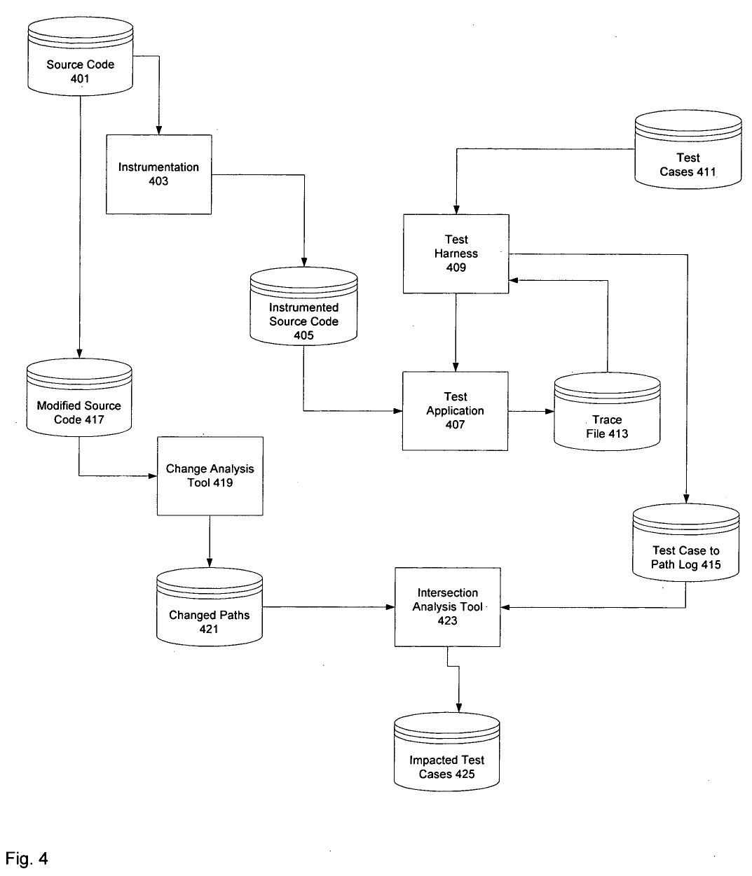

In one embodiment, each test case is represented by a string of node numbers. Each node number represents a program module that a test case traverses or executes. An execution path may also be represented by a string of node numbers; each node is a module on the execution path. Test cases that intersect changed execution paths upon modification to the code are identified according to one embodiment. A test case intersects an execution path when the node strings of the test case and the execution path have at least one node number in common. Test cases intersecting changed paths may be executed to test modified code. FIG. 4 further illustrates elements of a software testing system using non-redundant test cases and the various processes therein according to one embodiment.

Source code 401 of a software program is first parsed and instrumented 403 using an instrumentation tool such as McCabe IQ. The instrumented source code 405 is then used to build an instrumented test application 407. Testing is performed by a test harness 409. The harness 409 takes individual test cases from a test case database 411 and passes them to the instrumented test application 407. As the application 407 executes, a trace file 413 is output, which records an executed path. The execution path is recorded as a set of node numbers, representing modules executed by the program. For each test case that executes, the harness 409 reads the trace file 413 into a string variable. Linefeeds may be replaced with commas such that a single string is constructed from multiple lines of node numbers. The string value is then inserted into a hash table. The paths may be given identification numbers or names, which in turn may be used as hash keys. Concatenated path notations or other information may also be used as hash keys. A test case may be labeled as redundant or non-unique if its path string is a duplicate of an existing hash value, for it would execute the same path as another test case. A test case to path log 415 may be created to store information on all test cases, including test case identifiers, concatenated path strings, and test case labels (for redundant and non-redundant test cases). This process iterates until all test cases have been executed and the paths they execute have been recorded.

When source code 401 is modified, the modified source code 417 is parsed using a change analysis tool 419 such as McCabe Change or other suitable means. The change analysis tool 419 identifies which code paths have been altered by the code modification, as discussed above. Once the changed paths 421 have been identified, an intersection analysis tool 423 is used to identify test cases that intersect the changed path, based on the recorded path information in the test case to path log 415. A test case intersects a path when the node strings representing the test case and the path share one or more node numbers. An iterative process may be used to scan each test case string against the strings of all the changed paths to identify those that intersect the changed paths. Alternatively, an inverted index may be maintained, which indexes each node to a list of test cases that use the node; the intersection analysis can then match each node in the changed test paths against the index to find the appropriate test cases. The identified test cases are then executed to test the modified code. Those test cases that do not intersect the changed paths do not need to be executed again as they test the part of the code that remains unchanged.

Therefore, the software testing system for non-redundant software testing on code modifications includes means for identifying changed paths and means for identifying test cases intersecting the changed paths. These identifying means may be hardware, software, firmware, or combinations thereof in various embodiments.

It is to be understood that the description, specific examples and data, while indicating exemplary embodiments, are given by way of illustration and are not intended to limit the various embodiments of the present disclosure. All references cited herein are specifically incorporated by reference in their entireties. Various changes and modifications within the present disclosure will become apparent to a skilled artisan from the description, examples, and data contained herein, and thus are considered part of the various embodiments of this invention.

1. A method for testing changes in a software program using a plurality of test cases, wherein the software program comprises a first plurality of execution paths, the method comprising:
identifying one or more changed paths in the first plurality of execution paths;
from the plurality of test cases, identifying one or more test cases that are capable of executing the one or more changed paths; and
executing the one or more of the identified test cases to test the changed path.

2. The method of claim 1, wherein the software program comprises one or more modules, and identifying one or more test cases comprises identifying a changed module and determining whether the changed module causes changes in the execution paths.

3. The method of claim 1, wherein identifying one or more test cases comprises identifying a second plurality of execution paths in the software program and determining the difference between the first and second pluralities of execution paths.

4. The method of claim 3, wherein the difference comprises at least one of a new path and a changed path.

5. The method of claim 1, wherein identifying one or more test cases comprises evaluating names of one or more methods of a test case from the plurality of test cases thereby determining whether the methods of the test case involve the one or more changed paths.

6. The method of claim 5, wherein identifying one or more test cases further comprises evaluating parameters of one or more methods of a test case from the plurality of test cases thereby determining whether the methods of the test case involve the one or more changed paths.

7. The method of claim 1, wherein identifying one or more test cases comprises determining whether a test case intersect one or more changed paths.

8. The method of claim 7, wherein determining whether a test case intersect one or more changed execution paths comprises identifying a module of the software program included in both the test case and a changed execution path.

9. The method of claim 8, wherein each module is represented by a node number, and each execution path and test case is represented by a string of node numbers, wherein identifying a module comprises identifying a node number included in both a changed execution path and a test case.

10. A computer program product for testing a software program using a plurality of test cases, the computer program product comprising a computer usable medium having a computer readable program code embodied thereon, the computer readable program code controlling the computer to perform the operations of:
identifying one or more changed paths in a first plurality of execution paths of the software program;
identifying one or more test cases that are capable of executing the one or more changed paths; and
executing the identified one or more test cases to test the changed code of the software program.

11. The computer program product of claim 10, wherein the software program comprises one or more modules, wherein identifying one or more paths comprises identifying the changed module and determining whether the changed module causes changes in the execution paths.

12. The computer program product of claim 10, wherein identifying one or more paths comprises identifying a second plurality of execution paths in the software program upon changing of the code and determining the difference between the first and second pluralities of execution paths.

13. The computer program product of claim 12, wherein the difference comprises at least one of a new path and a changed path.

14. The computer program product of claim 10, wherein identifying one or more test cases comprises evaluating the names of one or more methods of a test case from the plurality of test cases thereby determining whether the methods of the test case involves the one or more changed paths.

15. The computer program product of claim 14, wherein identifying one or more test cases further comprises evaluating the parameters of one or more methods of a test case from the plurality of test cases thereby determining whether the methods of the test case involve the one or more changed paths.

16. The computer program of claim 10, wherein identifying one or more test cases comprises determining whether a test case intersects one or more changed paths.

17. The computer program of claim 16, wherein determining whether a test case intersect one or more changed execution paths comprises identifying a module of the software program included in both the test case and a changed execution path.

18. The computer program of claim 17, wherein each module is represented by a node number, and each execution path and test case is represented by a string of node numbers, wherein identifying a module comprises identifying a node number included in both a changed execution path and a test case.

19. A system for testing changes in a software program using a plurality of test cases, wherein the software program comprises a first plurality of execution paths, the system comprising:
means for identifying one or more changed paths in the first plurality of execution paths;
means for identifying one or more test cases from the plurality of test cases that are capable of executing the one or more changed paths,
wherein the one or more identified test cases are executed to test the changed code of the software program.

20. The system of claim 19, wherein the software program comprises one or more modules, wherein upon changing of the code at least one module is changed, and wherein identifying one or more test cases comprises identifying the changed module and determining whether the changed module causes changes in the execution paths.

21. The system of claim 19, wherein identifying one or more test cases comprises identifying a second plurality of execution paths in the software program upon changing of the code and determining the difference between the first and second pluralities of execution paths.

22. The system of claim 21, wherein the difference comprises at least one of a new path and a changed path.

23. The system of claim 19, wherein identifying one or more test cases comprises evaluating names of one or more methods of a test case from the plurality of test cases thereby determining whether the methods of the test case involve the one or more changed paths.

24. The system of claim 23, wherein identifying one or more test cases further comprises evaluating the parameters of one or more methods of a test case from the plurality of test cases thereby determining whether the methods of the test case involve the one or more changed paths.

25. The system of claim 19, wherein identifying one or more test cases comprises determining whether a test case intersects one or more changed paths.

26. The system of claim 25, wherein determining whether a test case intersect one or more changed execution paths comprises identifying a module of the software program included in both the test case and a changed execution path.

27. The system of claim 26, wherein each module is represented by a node number, and each execution path and test case is represented by a string of node numbers, wherein identifying a module comprises identifying a node number included in both a changed execution path and a test case.
